(19) United States
(12) Patent Application Publication
(10) Pub. No.: US 2007/0165007 A1
(43) Pub. Date: Jul. 19, 2007

(54) Interactive input system

(76) Inventors: Gerald Morrison, Calgary (CA); Trevor Akitt, Calgary (CA); Vaughn Edward Keenan, Calgary (CA)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/331,448

(22) Filed: Jan. 13, 2006

(51) Int. Cl. G06F 3/042

(52) U.S. Cl. 345/175

(57) ABSTRACT

An interactive input system comprises at least two imaging devices associated with a region of interest. The at least two imaging devices acquire images of the region of interest from different locations and have overlapping fields of view. At least one receiver is operable to receive data output by an active pointer when the pointer is both within and outside the fields of view of the imaging devices. Processor structure processes data acquired by the at least two imaging devices and the at least one receiver to detect the existence of an active pointer and to determine the location of the pointer within the region of interest.

### CROSS-REFERENCE TO RELATED APPLICATIONS

This application is related to U.S. patent application Ser. No. 10/312,983 filed on Sep. 7, 2004 entitled “Camera-Based Touch System”, which is related to U.S. patent application Ser. No. 09/610,481 filed on Jul. 5, 2000, now U.S. Pat. No. 6,803,906, the contents of which are incorporated herein by reference.

### FIELD OF THE INVENTION

The present invention relates generally to input systems and in particular to an interactive input system.

### BACKGROUND OF THE INVENTION

Interactive input systems are well known in the art and typically include a touch screen having a touch surface on which contacts are made using a pointer in order to generate user input. Pointer contacts with the touch surface are detected and are used to generate corresponding output depending on areas of the touch surface where the contacts are made. Common touch systems utilize analog resistive, electromagnetic, capacitive, acoustic or machine vision to identify pointer instructions with the touch surface.

For example, U.S. patent application Ser. No. 10/312,983 to Morrison et al. discloses a camera-based touch system comprising a touch screen that includes a passive touch surface on which a computer-generated image is presented is disclosed. A rectangular bezel or frame surrounds the touch surface and supports digital cameras at its corners. The digital cameras have overlapping fields of view that encompass and look across the touch surface. The digital cameras acquire images from different locations and generate image data. Image data acquired by the digital cameras is processed by digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y)-coordinates relative to the touch surface using triangulation. The pointer coordinate data is conveyed to a computer executing one or more applications programs. The computer uses the pointer coordinate data to update the computer-generated image that is presented on the touch surface. Pointer contacts on the touch surface can therefore be recorded as writing or drawing or used to control execution of applications programs executed by the computer.

U.S. patent application Ser. No. 10/838,536 to Morrison et al. discloses yet another camera-based touch system. This touch system comprises a generally rectangular touch surface comprising at least two spaced imaging devices having overlapping fields of view encompassing the touch surface. The imaging devices see the touch surface in three-dimensions as a perspective view with the view at a minimum including the four corners of the touch surface. The imaging devices acquire overlapping images from different locations. A processor receives and processes image data generated by at least one of the imaging devices to determine the location of the pointer relative to the touch surface using triangulation.

The camera-based touch systems described above are particularly suited for use with a passive pointer such as a finger or cylinder of material, although active pointers can be used. In low light environments when a passive pointer is used, an illuminated bezel such as that described in U.S. patent application Ser. No. 10/354,168 to Akitt et al., now U.S. Pat. No. 6,972,401, may be employed to surround the touch surface and provide suitable backlighting to enhance passive pointer detection.

Touch systems designed for use with active pointers are also well known. For example, U.S. Pat. No. 6,529,189 to Colgan et al. discloses a touch screen stylus with IR-coupled selection buttons. The stylus is wireless and includes an infrared emitter for communicating with a receiver associated with a computer. The stylus is provided with push-buttons near its tip that can be actuated by a user during the course of pointing the stylus at a touch screen location. Combined actuations of the touch screen and a concurrent actuation of one or more of the push-buttons allows a mouse input to the computer to be accomplished.

Although the above touch systems are satisfactory, improvements to interactive input systems are desired. It is therefore an object of the present invention to provide a novel interactive input system.

### SUMMARY OF THE INVENTION

According to one aspect there is provided an interactive input system comprising:

at least two imaging devices associated with a region of interest, said at least two imaging devices acquiring images of said region of interest from different locations and having overlapping fields of view;

at least one receiver operable to receive data output by an active pointer when said pointer is both within and outside the fields of view of said imaging devices; and

processor structure processing data acquired by said at least two imaging devices and said at least one receiver to detect the existence of an active pointer and to determine the location of said pointer within said region of interest.

According to another aspect there is provided a camera-based interactive display system comprising:

display;

a region of interest in front of said display;

at least two optical recording devices acquiring images of said region of interest from different locations and having overlapping fields of view;

at least one receiver operable to receive data output by an active pointer when said pointer is within and outside the fields of view of said optical recoding devices; and

processing structure receiving and processing data acquired by said at least two optical recording devices and said at least one receiver to detect the existence of a pointer and to determine the location of said pointer within said region interest.

### BRIEF DESCRIPTION OF THE DRAWINGS

Embodiments will now be described more fully with reference to the accompanying drawings in which:

FIG. 1 is a schematic diagram of a camera-based interactive input system;

FIG. 2 is a schematic block diagram of an active pointer;

FIG. 3 is a modulated IR carrier signal output by the active pointer of FIG. 2;

FIG. 4 is a schematic diagram of a portion of the interactive input system of FIG. 1 showing the lines of sight of IR receivers to an active pointer adjacent a touch surface; and

FIG. 5 is another schematic diagram of a portion of the interactive input system of FIG. 1 showing the line of sight of each IR receiver to an active pointer positioned remote from a touch surface;

### DETAILED DESCRIPTION OF THE EMBODIMENTS

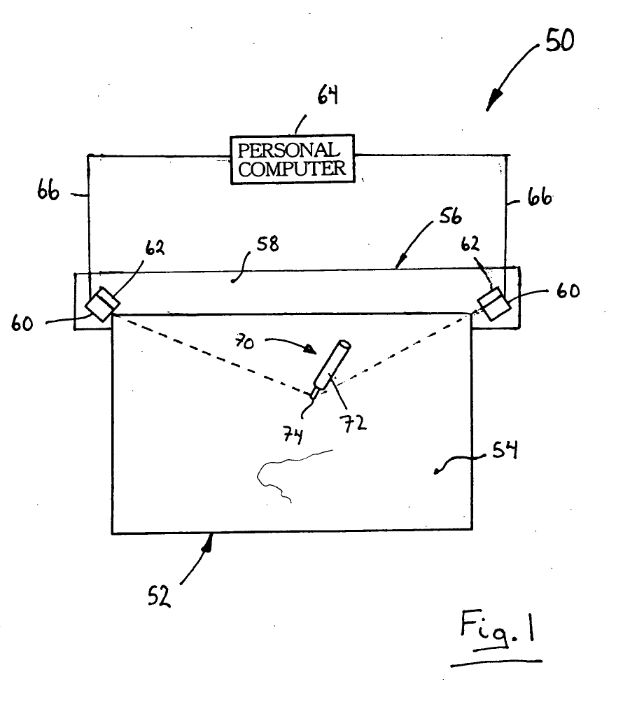

Turning now to FIG. 1, a camera-based interactive input system is shown and is generally identified by reference numeral 50. As can be seen, touch system 50 includes a touch screen 52 having a touch surface 54 defining a region of interest on which pointer contacts are to be made. In this embodiment, the touch screen 52 is the generally planar surface of a flat panel display device such as for example an LCD, plasma, HDTV or other television display device. A sensor assembly 56 extends along one side of the touch screen 52. The sensor assembly 56 includes a valence 58 secured to one side edge of the touch screen 52. Digital cameras 60 are positioned adjacent opposite ends of the valence 58. The fields of view of the digital cameras 60 overlap over the entire active area of the touch surface 54 so that pointer contacts made on the touch surface can be visually detected.

An infrared (IR) receiver 62 is positioned adjacent to and communicates with an associated digital camera 60. Each IR receiver 62 is similar to those found on consumer electronics and comprises a lensed IR detector coupled to a gain controlled amplifier. The digital cameras 60 are coupled to a computer or other suitable processing device 64 via a high speed data bus 66 such as for example USB-2. Computer 64 executes one or more application programs and provides display output that is visible on the touch screen 52. The touch screen 52, computer 64 and display device form a closed-loop so that pointer contacts with the touch screen 52 can be recorded as writing or drawing or used to control execution of application programs executed by the computer 64.

Each digital camera 60 includes a two-dimensional CMOS image sensor and associated lens assembly and an on-board processing device such as a digital signal processor (DSP) or other processing device. As will be appreciated, the digital cameras are similar to those described in U.S. patent application Ser. No. 10/312,983. The image sensor is configured to capture images over a wide range of frame rates up to 200 frames per second.

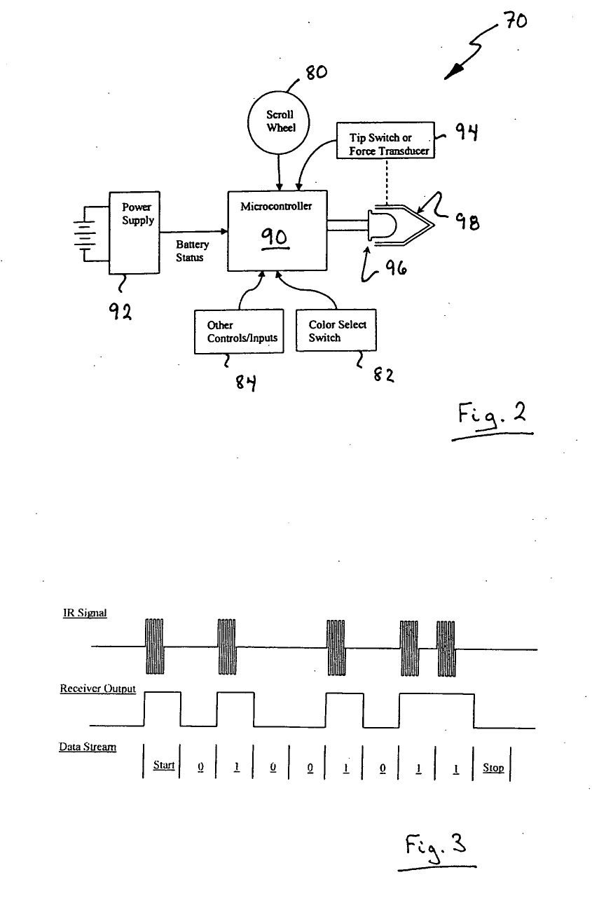

In this embodiment, an active pointer 70 is used to interact with the touch surface 54. As shown in FIG. 2, the active pointer 70 includes a pointer body 72 having a tip 74 at one end designed to be brought into contact with the touch surface. A scroll wheel 80, color select switch 82 and one or more other pointer controls 84 such as for example, a right mouse click button, a help button, an ink style selector button and multiple choice answer or voting buttons (good for classroom/teaching environments), are provided on the pointer body 72. A microcontroller 90 is disposed within the pointer body 72 and communicates with the scroll wheel 80, color select switch 82 and other pointer controls 84. The microcontroller 90 receives power from a rechargeable battery 92 that is also accommodated within the pointer body 72. A force transducer 94 in the pointer body 72 provides input to the microcontroller 90 when the pointer is brought into contact with the touch surface. An infrared (IR) transmitter 96 in the form of an IR light emitting diode (LED) surrounded by a diffuser 98 are also provided at the tip of the pointer body 72.

The general operation of the touch system 50 will now be described. Each digital camera 60 acquires images looking across the touch surface 60 within its field of view at a desired frame rate. When the pointer 70 is brought into contact with the touch surface 54 with sufficient force to actuate the force transducer 94, the microcontroller 90 energizes the IR transmitter 96 in the tip 74 thereby causing the pointer 70 to illuminate. In particular, when the IR transmitter 96 is energized, the IR transmitter outputs an IR carrier signal. Thus, as the digital cameras 60 capture images looking across the touch surface 54, the illuminated pointer tip 74 appears as a bright point of illumination against a dark background.

In addition, upon actuation of the force transducer 94 as a result of a pointer contact on the touch surface 54, the microcontroller 90 modulates the IR carrier signal output by the IR transmitter 92 so that the modulated IR carrier signal carries data signifying the pointer down condition. The IR carrier signal is sufficiently strong allowing it to be acquired by the IR receivers 62. The DC offset level of the IR carrier signal is also sufficient to ensure that enough optical energy is received by the digital cameras 60 during a pointer contact with the touch surface to detect reliably the illuminated pointer at the selected camera frame rate and at the maximum pointer distance from the digital cameras 60 as shown in FIG. 3. Using this scheme, the digital cameras 60 will see a constant illumination of the pointer 70 when it is in contact with the touch surface 54.

When the IR receivers 62 receive the modulated IR carrier signal output by the pointer 70, the amplifiers of the IR receivers 62, which are tuned to the frequency of the IR carrier signal, decode the modulated IR carrier signal. In this manner, the data embodied in the IR carrier signal is extracted and is output as a data stream to the DSP of each digital camera 60.

The DSP of each digital camera 60 synchronizes the data received from the IR receiver 62 with the acquired image data, compresses the data, and transmits the data to the computer 64 via the high speed link 66. Upon receipt of the data, the computer 64 processes the data output by the IR receivers 62 to verify that a pointer down event has occurred. Once the pointer down event has been verified, the computer 64 processes captured images to determine the location of the pointer 70.

During processing of captured images, if a pointer is in the acquired images and the pointer down condition has been verified, the images are processed by the computer 64 to generate characteristic data identifying the pointer position in the acquired images. The pointer characteristic data is then used by the computer 64 to determine the location of the pointer in (x,y)-coordinates using triangulation. In particular, images are processed by the computer 64 in a manner similar to that described in U.S. patent application Ser. No. 10/294,917 to Morrison et al., assigned to SMART Technologies Inc., assignee of the subject application, the content of which is incorporated by reference. In this manner, a bounding box surrounding the pointer contact on the touch surface 54 is determined allowing the location of the pointer in (x,y)-coordinates to be calculated. The pointer position data is recorded as writing or drawing if the pointer contact is a write event or is injected into the active application program being run on the computer 64 if the pointer contact is a mouse event. The computer 64 also updates output conveyed to the display device so that the image visible on the touch surface 54 reflects the pointer activity. As will be appreciated, in order for images to be processed pointer down data must be received. In this manner, pointer decoys appearing in acquired images can be resolved and disregarded.

When a pointer up event occurs, the microcontroller 90 modulates the IR carrier signal so that it carries data signifying the pointer up condition. In response to receiving data representing the pointer up condition, the computer 64 clears the pointer down condition inhibiting images from being processed until the next pointer down event occurs and is verified. As will be appreciated, this further enhances the ability of the system 50 to resolve and disregard pointer decoys appearing in acquired images.

When the computer 64 receives data from the digital cameras 60 and a pointer down condition has not been verified, the images are not processed to detect the existence and location of a pointer unless the hover button on the pointer 70 has been depressed. In this case, actuation of the hover button results in hover data being used to modulate the IR carrier signal. As a result, the hover data is received by the computer 64 with the image data. In response to the hover data, the computer 64 processes the images to determine the pointer location.

In other instances only the data generated by the IR receivers 62 is processed by the computer 64 so that the appropriate functions are invoked such as scrolling, ink style adjusting etc. In particular, when user input is generated through actuation of the scroll wheel 80, color select switch 82 or other pointer controls 84, the microcontroller 90 modulates the IR carrier signal so that it includes data representing the user input. In addition to data representing user input, the microcontroller 90 also modulates the IR carrier signal to include data representing the force applied to the touch surface 54 using the pointer 70 as well as data representing the status of the battery 92. This allows the line thickness to be varied based on applied force during write events and allows a visual on-screen display of pointer battery life to be provided.

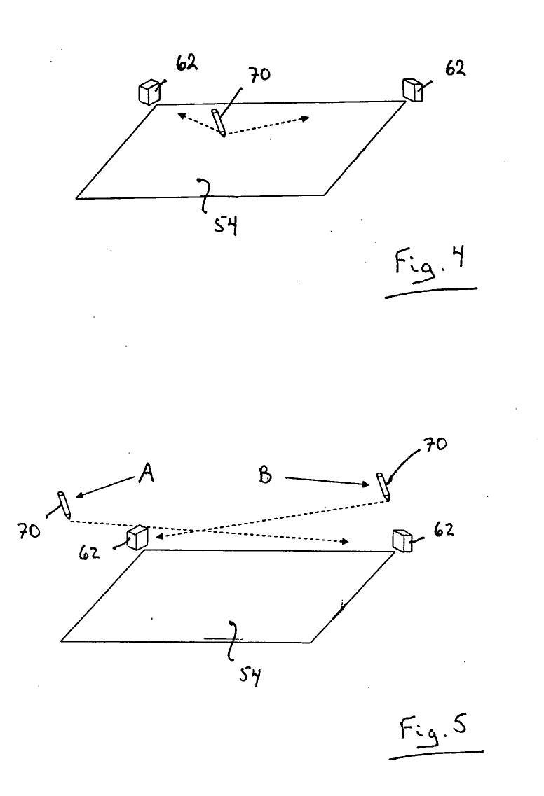

Although the color select switch 82 may be selected at any time, data representing the selected color is only output by the pointer when the pointer 70 is in contact with the touch surface 54. Thus, color changes only occur during write events. On the other hand, as the scroll wheel 80 is active irrespective of whether the pointer 70 is in contact with the touch surface 54, scroll commands can be output by the pointer 70 even when the pointer is remote from the touch surface and outside of the fields of view of the digital cameras 60. To permit such operation, the fields of view of the IR receivers 62 are sufficiently wide to detect IR carrier signal output of the pointer 70 when the pointer is proximate to the touch surface 54 as shown in FIG. 4 as well as when the pointer 70 is remote from the touch surface 54 as shown in FIG. 5. In the scenario shown in FIG. 5, at pointer positions A and B only one of the IR receivers 62 receives the IR carrier signal output of the pointer 70.

Although the touch system 50 has been described as including a display device to provide images that are visible on the touch screen 54, those of skill in the art will appreciate the display device is not required. Also, rather than being a flat panel display device, the display device may be a front or rear projector projecting images on the touch surface, a video monitor over which the touch screen 52 is placed, or other device that presents an image that is visible when looking at the touch surface 54. Also, the touch screen 54 need not be rectangular. The touch screen may in fact be virtually any surface of basically any shape such as for example a table top, wall surface etc.

Although digital cameras similar to those in U.S. patent application Ser. No. 10/312,983 are described, it will be appreciated that other imaging or optical recording devices can be used to acquire overlapping images of the region of interest. For example, the cameras may be stand-alone imaging devices such as those disclosed in U.S. patent application Ser. No. 10/838,536 to Morrison et al. In this case, the cameras have overlapping fields of view encompassing a volume of interest. As the cameras are stand-alone, the need for a valence is not required. It will also be appreciated that the IR receivers may be integrated into the camera devices.

Although the computer 64 is described as processing the image data, those of skill in the art will appreciate that the on-board processing capabilities of the digital cameras may be used to handle some or all of the image processing.

In the embodiment discussed above, the digital cameras are described as communicating with the personal computer 64 via a wired high speed data link. Those of skill in the art will appreciate that variations are possible and that other wired connections may be used to convey the data to the computer. For example, the output of the IR receives 62 may be conveyed directly to the computer 64 via UART, USB or other suitable connections. Alternatively, the data from the IR receivers and digital cameras may be conveyed to the computer over a wireless communications link.

The configuration of the pointer 70 is exemplary and variations are of course possible. For example, the IR LED transmitter and diffuser arrangement may be replaced with multiple IR LEDs mounted about the tip with overlapping fields of view. Of course, different means of transmitting data may be employed by the pointer. For example, radio frequency (RF) communications may be employed. Also, a tip switch may be used instead of the force transducer to allow the microcontroller to detect when pointer down events have occurred. The pointer may also employ a non-rechargeable power source. If desired, the pointer may include a microphone and the microcontroller 90 may execute voice recognition software to allow a user to enter user input via voice commands rather than or in addition to the actuation of buttons on the pointer.

In addition, the pointer may include a wireless communications receiver to allow the pointer to receive commands from the computer 64. In this manner, functions of the pointer can be enabled or disabled or functions attributed to buttons on the pointer re-assigned or changed providing the pointer with context sensitive soft button capabilities.

Although preferred embodiments of the present invention have been described, those of skill in the art will appreciate that variations and modifications may be made without departing from the spirit and scope thereof as defined by the appended claims.

What is claimed is:

1. An interactive input system comprising:
at least two imaging devices associated with a region of interest, said at least two imaging devices acquiring images of said region of interest from different locations and having overlapping fields of view;
at least one receiver operable to receive data output by an active pointer when said pointer is both within and outside the fields of view of said imaging devices; and
processor structure processing data acquired by said at least two imaging devices and said at least one receiver to detect the existence of an active pointer and to determine the location of said pointer within said region of interest.

2. An interactive input system according to claim 1, comprising at least two receivers, each receiver being positioned adjacent a different one of said imaging devices.

3. An interactive input system according to claim 1, further comprising a touch surface positioned in said region of interest.

4. An interactive input system according to claim 3, wherein each imaging device is positioned adjacent a different corner of said touch surface.

5. An interactive input system according to claim 2 wherein data received by said receivers is synchronized with image data acquired by said imaging devices.

6. An interactive input system according to claim 5 wherein data received by each receiver is conveyed to said associated imaging device prior to transmission to said processing structure by said imaging device.

7. An interactive input system according to claim 6 wherein said imaging devices transmit data to said processing structure over a wired communications link.

8. An interactive input system according to claim 6 wherein said imaging devices transmit data to said processing structure over a wireless communications link.

9. An interactive input system according to claim 5 wherein said receivers and imaging devices independently transmit data to said processing structure.

10. An interactive input system according to claim 9 wherein said imaging devices and receivers transmit data to said processing structure over a wired communications link.

11. An interactive input system according to claim 9 wherein said imaging devices and receivers transmit data to said processing structure over a wireless communications link.

12. An interactive input system according to claim 3 further comprising an active pointer, said pointer outputting data in response to a contact with said touch surface.

13. An interactive input system according to claim 12 wherein said pointer outputs data in response to a contact with said touch surface made with a threshold force.

14. An interactive input system according to claim 13 wherein said pointer includes at least one manually actuable control, said pointer outputting data in response to control actuation.

15. An interactive input system according to claim 14 wherein said pointer outputs data in response to control actuation only when a pointer contact condition exists.

16. An interaction input system according to claim 3 wherein said pointer illuminates in response to a contact with said touch surface.

17. An interactive input system according to claim 16 wherein said pointer illuminates in response to a contact with said touch surface made with a threshold force.

18. An interactive input system according to claim 17 wherein said pointer includes at least one manually actuable control, said pointer outputting data in response to control actuation.

19. An interactive input system according to claim 18 wherein said pointer outputs data in response to control actuation only when a pointer contact condition exists.

20. An interactive input system according to claim 19 wherein said data is used to modulate light output by said pointer.

21. A camera-based interactive display system comprising:
display;
a region of interest in front of said display;
at least two optical recording devices acquiring images of said region of interest from different locations and having overlapping fields of view;
at least one receiver operable to receive data output by an active pointer when said pointer is within and outside the fields of view of said optical recoding devices; and
processing structure receiving and processing data acquired by said at least two optical recording devices and said at least one receiver to detect the existence of a pointer and to determine the location of said pointer within said region interest.

22. A camera-based interactive display system according to claim 21 further comprising an active pointer.
